(19) United States
(12) Patent Application Publication
(10) Pub. No.: US 2026/0223829 A1
(43) Pub. Date: Aug. 6, 2026

(54) AUTOMATIC HOOK-SETTING AND FISH ALERTING ROD HOLDER WITH ADJUSTABLE SENSITIVITY

(71) Applicants: RAY GUOSHENG ZHU, REDWOOD CITY, CA (US); KEVIN P ZHU, REDWOOD CITY, CA (US)

(72) Inventors: RAY GUOSHENG ZHU, REDWOOD CITY, CA (US); KEVIN P ZHU, REDWOOD CITY, CA (US)

(21) Appl. No.: 19/454,269

(22) Filed: Jan. 20, 2026

Related U.S. Application Data
(60) Provisional application No. 63/752,856, filed on Feb. 2, 2025.
(60) Provisional application No. 63/756,231, filed on Feb. 9, 2025.
(60) Provisional application No. 63/759,245, filed on Feb. 17, 2025.
(60) Provisional application No. 63/776,125, filed on Mar. 23, 2025.
(60) Provisional application No. 63/928,728, filed on Dec. 1, 2025.
(60) Provisional application No. 63/940,521, filed on Dec. 14, 2025.

(51) Int. Cl. A01K 97/11

(52) U.S. Cl. CPC A01K 97/11

(57) ABSTRACT

An automatic hook-setting rod holder featuring dual sensitivity adjustment mechanisms. The device includes a base, a biased rod-receiving member, and a trigger mechanism with a leveraged sear. A primary sensitivity assembly allows manual threshold adjustment via a vertical vector acting perpendicular to the primary biasing friction, enabling calibration independent of hook-setting tension. Additionally, sensitivity is adjustable by longitudinally repositioning the fishing rod to vary the torque applied to the trigger relative to a fulcrum. The rod-receiving member features a retention section acting as a fixed fulcrum to amplify rod deflection while preventing ejection. The sensitivity assembly includes a lockout state, converting the device into a stationary rod holder.

### CROSS-REFERENCE TO RELATED APPLICATIONS

This application claims the benefit of and priority to the following U.S. Provisional Patent Applications: No. 63/752,856, filed Feb. 2, 2025. No. 63/756,231, filed Feb. 9, 2025. No. 63/759,245, filed Feb. 17, 2025. No. 63/776,125, filed Mar. 23, 2025. No. 63/928,728, filed Dec. 1, 2025. No. 63/940,521, filed Dec. 14, 2025.

### FIELD OF THE INVENTION

The present invention relates generally to fishing equipment and hook-setting devices. More particularly, the invention relates to an automatic hook-setting rod holder having a decoupled sensitivity adjustment mechanism that operates independently of the primary hook-setting force, and which further functions as a multi-mode device capable of static rod holding and electronic fish alerting.

### BACKGROUND OF THE INVENTION

The sport of fishing often requires immediate mechanical action to set a hook once a fish has struck a bait or lure. To assist with this, various automatic hook-setting devices have been developed to improve catch rates and allow anglers to manage multiple lines simultaneously.

The majority of conventional automatic hook-setters are line-triggered, requiring the fishing line to be looped around a specialized trigger arm. These systems are prone to tangling, are difficult to set in windy conditions, and often interfere with the angler's ability to “feel” the line during retrieval. A smaller subset of devices utilizes rod-deflection triggers, which are activated by the physical bending of the fishing rod itself. However, these deflection-based systems typically suffer from a significant mechanical drawback: force dependency.

In most rod-deflection prior art, the primary spring providing the hook-setting power also generates the high frictional force that holds the trigger latch in place. Because these systems lack a decoupled sensitivity mechanism, any sensitivity “adjustment” is typically limited to two flawed methods: (1) Reducing Sear Engagement: Users must barely engage the latch edge to reduce friction, resulting in dangerous, unstable “hair-trigger” states that can discharge prematurely due to wind or wave action; or (2) Opposing the Primary Force: Adjustments attempt to mechanically fight the primary biasing friction in a parallel, linear vector. Consequently, a “heavy” setting requires a massive amount of fish-driven force to trigger, while a “light” setting becomes unreliable under high tension.

Critically, in prior art rod-deflection devices (such as U.S. Pat. No. 7,017,296B2), the primary biasing force functions as a structural prerequisite for maintaining trigger stability. In the absence of this high-tension spring, the sear arm lacks inherent stability. Consequently, sensitivity adjustment in these systems is dependent on the biasing load—attempting to counter-balance variable friction rather than independently calibrating for a fish strike. In contrast, the present invention features a decoupled sensitivity assembly in which trigger stability does not rely on the presence or magnitude of the primary biasing force. This independent adjustment allows the device to function as a precise strike indicator even in the total absence of the primary hook-setting force.

There exists a need for a mechanism that provides precision adjustment by applying a secondary, independent force to the trigger assembly, allowing the user to set the release threshold truly based on rod, reel and fish species with high precision, without altering the primary hook-setting power.

Furthermore, existing rod-deflection holders are often cumbersome to load. Because the rod must be forced into the trigger mechanism against the main spring, there is a high risk of accidental discharge during setup. Additionally, most of these devices are specialized tools that cannot safely function as standard, static rod holders, requiring the angler to carry separate equipment for non-automatic fishing.

Therefore, there is a distinct need for a hook-setting rod holder that utilizes rod deflection but effectively decouples the hook-setting force from the trigger sensitivity. Specifically, there is a need for a mechanism where the trigger force acts perpendicularly to the primary friction vector, allowing for a light, consistent vertical release regardless of the primary spring tension, and a design that allows the device to be safely locked into a static holder mode.

### SUMMARY OF THE INVENTION

The present invention provides an automatic hook-setting rod holder featuring a trigger architecture that optimizes sensitivity by aligning adjustment forces with the vertical vector of a fish strike. The device generally comprises a base and a rod-receiving member pivotally mounted thereto, biased by a high-tension primary spring toward a released position. The rod-receiving member is maintained in a cocked position by a trigger mechanism comprising a latch bar and a leveraged sear.

A central technical advancement of the invention is the sensitivity adjustment assembly, designed to allow the user to manually set the trigger threshold based on the specific weight of the rod, reel, and target species. Unlike prior art devices where sensitivity adjustments typically oppose the primary biasing force, the present invention utilizes a secondary biasing force acting in a vertical vector. Because the force exerted by a fishing rod during a strike is substantially vertical, this vertical adjustment allows for precise setting of the release threshold. Crucially, this adjustment force operates perpendicular to the frictional force vector generated by the primary hook-setting spring. This orthogonal relationship allows the trigger to remain highly sensitive to light strikes even when the primary hook-setting force is set to a maximum level.

The trigger mechanism further incorporates a leveraged sear design. This design minimizes the influence of the horizontal friction generated by the primary biasing member to a negligible factor. By utilizing a high mechanical advantage, the sear ensures that the internal friction has nearly no interference on the trigger sensitivity. Consequently, the sensitivity adjustment acts directly against the sear arm to set a precise threshold based solely on the rod, reel, and target species. Because the primary biasing force is not a structural prerequisite for the trigger's stability, the sensitivity assembly remains functionally decoupled, allowing for independent calibration where the trigger threshold is set without regard to the load—or even the presence—of the main spring.

In addition to the spring-based adjustment, the invention features a geometric sensitivity mechanism based on variable leverage. The rod-receiving member is configured to support the fishing rod at varying longitudinal positions relative to the trigger. By sliding the rod forward or backward within the receiving cavity, the user alters the distance between the rod's center of gravity and the fulcrum point. This effectively changes the moment arm of the rod's weight, allowing the user to tune the trigger threshold by manipulating torque rather than spring tension. This method is supported by a versatile retention geometry—ranging from a narrowed snap-fit opening to a fully closed tubular perimeter—that acts as the fulcrum while preventing rod ejection.

Furthermore, in at least one embodiment, the invention utilizes the physical geometry of the rod-receiving member to provide mechanical advantage and maintain structural alignment. The proximal end of the member features a narrowed opening acting as a fixed fulcrum to provide a pivot point for the rod handle. In certain embodiments, this opening is configured to constrain the rod's axis of rotation, utilizing specific geometry (such as a slot or notch) to maintain the reel orientation—whether for spinning, baitcasting, or other reel types. By preventing the rod from twisting, the opening ensures that the rod's center of gravity remains aligned longitudinally with the actuator interface. This geometry ensures that the energy from a fish strike is amplified and translated efficiently into the vertical trigger vector without loss of force due to lateral shifting.

Finally, the device offers multi-mode utility derived from the absence of the primary force prerequisite. Unlike prior art that fails without the main spring, the present invention can function as a standalone, high-precision strike indicator even in the total absence of the primary hook-setting force. Additionally, the device supports a lockout mode; by advancing the sensitivity adjustment member to a hard stop, the latch becomes immobilized, converting the unit into a stationary rod holder for standard fishing.

### OBJECTS OF THE INVENTION

In view of the limitations of prior art hook-setting devices, the following are the primary objects of the present invention:
To provide a hook-setting rod holder with independent sensitivity: It is an object of the invention to provide a trigger mechanism wherein the force required to trigger the device is set by the user independently of the primary hook-setting spring tension, allowing for maximum setting power without sacrificing light-strike sensitivity.
To provide geometric sensitivity calibration: It is an object of the invention to enable sensitivity adjustment via the relative longitudinal positioning of the fishing rod and the actuator interface. By altering the distance between the rod's center of gravity and the fulcrum—either by sliding the rod or moving the trigger mechanism—the user can utilize the rod's own mass as a variable tuning parameter to set the trigger threshold.
To align adjustment with trigger force vectors: It is an object of the invention to provide a sensitivity adjustment assembly that operates on a vertical vector, matching the natural downward deflection of a fishing rod during a strike, thereby ensuring precise and predictable trigger thresholds.
To utilize orthogonal force management: It is an object of the invention to provide a trigger mechanism wherein the sensitivity adjustment force is applied perpendicular to the frictional force of the primary biasing element, preventing the adjustment mechanism from having to oppose or “fight” the main spring.
To provide mechanical advantage via a leveraged sear: It is an object of the invention to utilize a high-leverage sear design that converts a light vertical rod force into a low-torque rotation. This effectively renders internal friction negligible, ensuring that adjustment inputs act directly on the release threshold.
To maximize rod deflection and alignment via a fixed fulcrum: It is an object of the invention to incorporate a narrowed proximal opening in the rod-receiving member that acts as a fixed fulcrum while constraining rod rotation. This ensures that the rod handle functions as an efficient lever and that the rod's center of gravity remains aligned longitudinally with the actuator interface.
To provide a versatile multi-mode device: It is an object of the invention to provide a sensitivity assembly that functions independently of the primary spring, allowing the device to operate as a precise strike indicator even in the absence of the hook-setting force. Additionally, the assembly includes a lockout state, allowing the user to quickly convert the automatic hook-setting rod holder into a stationary rod holder for safe transport or non-automatic fishing.
To accommodate equipment variables: It is an object of the invention to allow the user to precisely set the trigger threshold to account for the specific weight of different rods, reels, and the resistance of various target species.

### BRIEF DESCRIPTION OF THE DRAWINGS

FIG. 1 is a side elevation view of the preferred embodiment of the automatic hook-setting rod holder (configured for a spinning reel) in the released position, identifying primary components including the base assembly, the rod-receiving member, and the primary biasing element.

FIG. 2 is a detailed perspective view of the leveraged sear member, illustrating the integrated monolithic structure of the latching surface and the actuator interface used to translate vertical rod deflection into rotational movement.

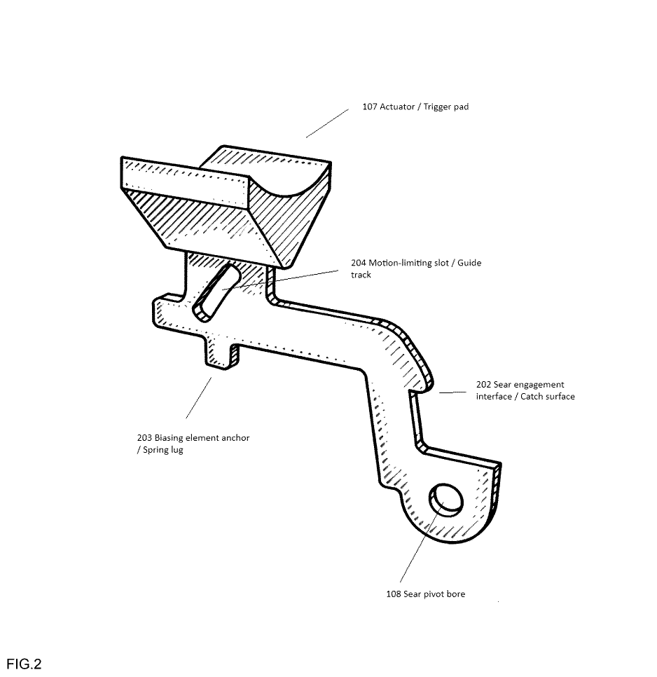

FIG. 3 is a longitudinal cross-sectional view of the trigger mechanism in the cocked position, illustrating the orthogonal relationship between the horizontal frictional force vector generated by the primary biasing element and the vertical adjustment vector applied by the sensitivity assembly.

FIG. 4 is a perspective view of the latch bar assembly with the rod-receiving member removed, revealing the internal pivot points, the latch-sear engagement interface, and the seating for the sensitivity adjustment member.

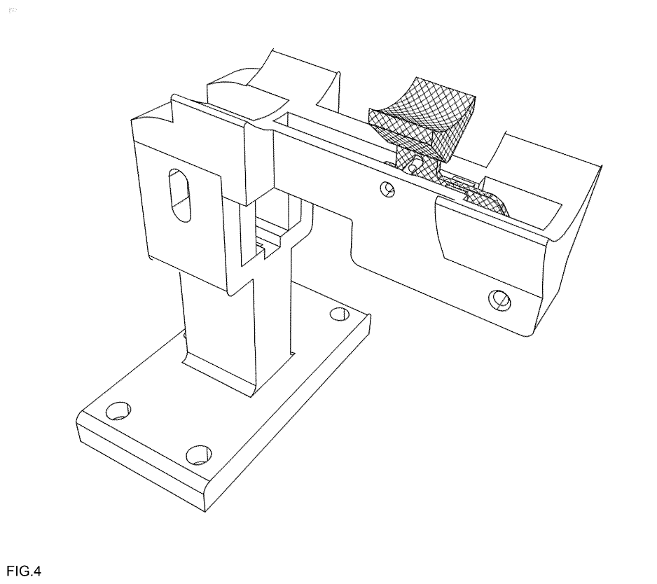

FIG. 5 is an operational diagram illustrating the hook-setting trajectory during a strike event, depicting the path of travel from the cocked (horizontal) position to the released (upright) position.

FIG. 6 is a right-side perspective view of the apparatus in the cocked position. This view specifically illustrates the narrowed opening located on the top surface of the proximal (rear) section of the rod-receiving member. The figure further illustrates a longitudinal positioning constraint 601 (depicted here as a resilient band, though mechanical clamps or collars are contemplated). These features cooperate to act as a fixed fulcrum and rotational constraint, capturing the rod handle to ensure the rod's center of gravity remains aligned with the actuator interface during a strike.

FIG. 7 is a left-side perspective view of the cocked apparatus, illustrating the external housing, the integrated accessory attachment points (or “ears”) for securing bells or straps, and the user-accessible interface of the sensitivity adjustment assembly.

FIG. 8 is a side elevation view of an alternative embodiment featuring a separate trigger cradle and an external sear arm, illustrating the adaptability of the perpendicular trigger logic to different mechanical form factors and the positioning of an optional limit switch sensor for the electronic alert mode.

FIG. 9 is a perspective view of the alternative embodiment of FIG. 8 mounted on a support structure with a fishing rod installed, illustrating the engagement of the rod handle with the external trigger cradle.

FIG. 10 is a detailed perspective view of the mounting stem and pivot joint, showing the interlocking radial face splines, the load-isolating compression bushing, and tilt-adjustment features that allow for incremental angular positioning of the device relative to the base.

FIG. 11 is a bottom perspective view of the apparatus, specifically illustrating the universal mounting interface located at the base of the stem. This view details the single-bolt slotted assembly configured to secure the device to varied supports, such as bucket lids, camera tripods, or clamp fixtures, utilizing either a top-down or bottom-up fastening orientation.

### DETAILED DESCRIPTION OF THE PREFERRED EMBODIMENTS

### Overview of the Apparatus

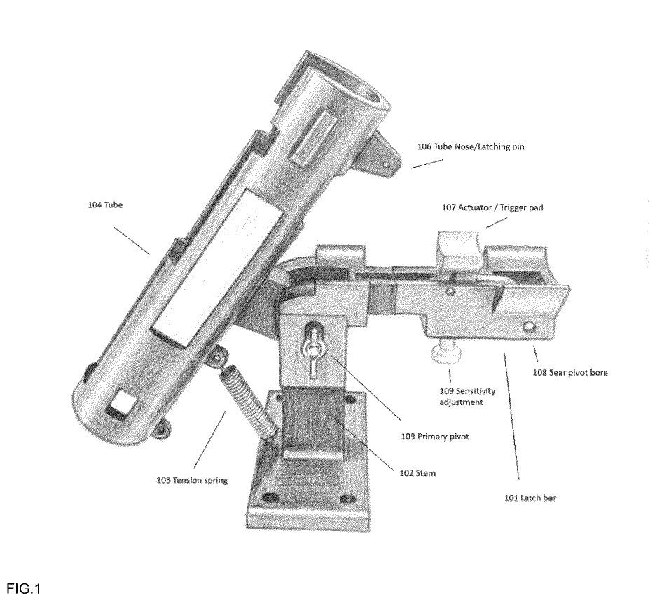

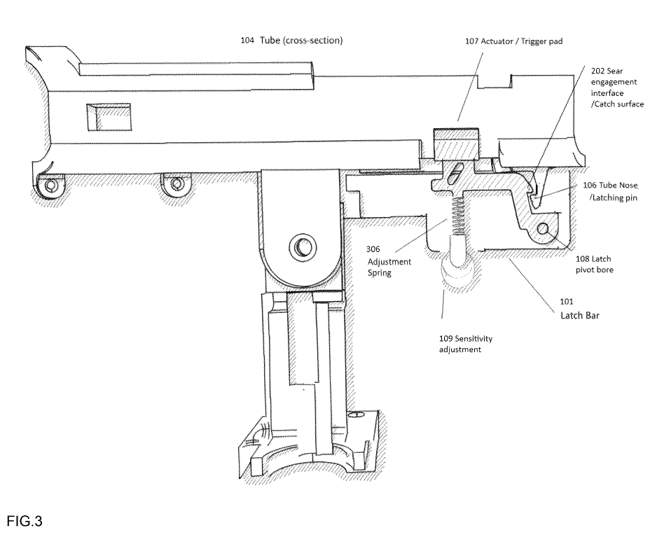

Referring to FIG. 1 and FIG. 3, the present invention comprises an automatic hook-setting and fish alerting apparatus configured to hold a fishing rod and automatically pivot said rod upward upon detection of a fish strike. The apparatus is generally comprised of a base assembly, a rod-receiving member, and a trigger mechanism. It is noted that the rod-receiving member 104 is labeled as ‘Tube’ in the accompanying drawings (e.g., FIG. 1) and is periodically referred to herein as the ‘tube’. These terms are used interchangeably to denote the component configured to support the fishing rod, and the invention is not limited to a strictly tubular geometry. The base assembly includes a stem adapted for mounting to a support surface—such as a bucket, dock, boat gunwale, or a stake driven into the ground—and a latch bar extending horizontally therefrom.

It should be noted that while the terms ‘vertical’ and ‘horizontal’ are used herein to describe the preferred orientation, these terms refer to the force vectors relative to the longitudinal axis of the rod-receiving member. The invention functions identically regardless of the absolute mounting angle relative to the ground.

### Layered Structural Architecture

In certain embodiments, the apparatus comprises a plurality of stacked or layered members arranged along a common axis, including a rod-supporting member, a trigger member, and a biasing member. These members are configured to permit relative rotation with respect to one another about a shared pivot axis while remaining structurally coupled. This layered arrangement allows the primary biasing load, trigger stability, and sensitivity adjustment functions to be structurally isolated from one another, thereby facilitating independent calibration, improved safety during loading, and modular adaptation of individual components without affecting the operation of the remaining layers.

### Structural Assembly and Angular Adjustment

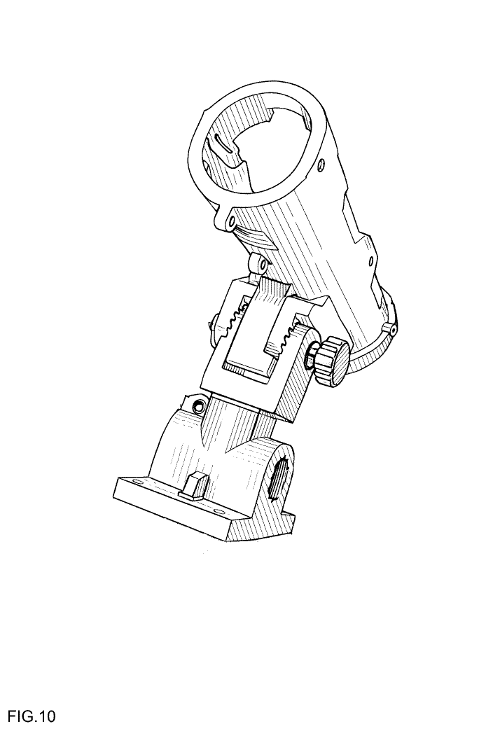

Referring specifically to FIG. 10, the connection between the stem of the base assembly and the latch bar incorporates a rigid angular adjustment assembly. This assembly comprises mating interlocking radial face splines configured to allow the user to incrementally adjust the angle of the latch bar relative to the stem. Unlike friction-based ball joints which may slip under the high torque of a hook set, these splines provide a positive mechanical lock at discrete angles. Crucially, this assembly utilizes a load-isolating compression sleeve (or bushing) positioned coaxially within the pivot joint. This sleeve is configured with a width dimension slightly greater than the width of the pivoting portion of the rod-receiving member. Consequently, when the user tightens the assembly to lock the angle of the stem and latch bar, the compressive clamping force is applied solely to the sleeve. This isolates the rod-receiving member from the clamping force, allowing it to rotate freely relative to the latch bar upon release, regardless of how tightly the mounting angle is secured.

Importantly, angular adjustment of the rod-receiving member relative to the base assembly is independent of trigger sensitivity and does not alter the release threshold of the trigger mechanism, which is governed solely by the sensitivity adjustment assembly and/or geometric leverage relationships described herein.

### The Trigger Mechanism and Orthogonal Force Decoupling

As detailed in the cross-sectional view of FIG. 3, the core of the invention is the trigger mechanism, which governs the release of the rod-receiving member. The mechanism comprises a latch—specifically a pivotable sear—and an actuator interface. In the preferred embodiment, these components are integrated into a monolithic unitary member pivotally mounted within the rod-receiving member. The trigger mechanism further incorporates a leveraged sear design. This design minimizes the influence of the horizontal friction generated by the primary biasing member to a negligible factor. By utilizing a high mechanical advantage, the sear ensures that the internal friction has nearly no interference on the trigger sensitivity. Consequently, the sensitivity adjustment acts directly against the sear arm to set a precise threshold based solely on the rod, reel, and target species, rather than compensating for variable internal friction. The trigger mechanism operates through an orthogonal decoupling of forces. When the apparatus is in the cocked position, the primary biasing element exerts a significant force that creates a frictional force vector acting substantially horizontally at the interface of the latch and the latching pin. Unlike prior art devices where sensitivity adjustments directly oppose this primary load, the present invention utilizes a sensitivity adjustment assembly that applies a secondary biasing force in a vector substantially perpendicular to the frictional force vector. The sensitivity adjustment assembly includes a threaded adjustment member and a resilient member, such as a compression spring. By rotating the adjustment member, the user varies the vertical pressure (normal force) on the sear. This allows for a precision-calibrated release threshold where the downward force of a fishing rod deflection acts to overcome the net sum of the perpendicular bias and the stabilized friction, rather than fighting the primary spring tension directly. The adjustment member or the rod-receiving member may further comprise visual indicia, such as graduated markings or alphanumeric symbols, to allow for repeatable sensitivity settings.

Substantially perpendicular includes any non-parallel orientation that avoids direct opposition to the primary biasing force, including angled or compound vectors.

### Alternative Biasing Elements

Although certain embodiments utilize mechanical springs as biasing elements, the sensitivity adjustment assembly and/or trigger mechanism may alternatively employ elastomeric members, rubber bands, compliant polymer elements, magnetic biasing assemblies, or hybrid combinations thereof. Such biasing elements may be selected to provide desired force-displacement characteristics, environmental resistance, cost advantages, or non-contact operation, without departing from the functional principles of the invention.

### Trigger Mechanism Variants

While the preferred embodiments describe a pivotable sear and actuator interface, the invention is not limited to any particular latch construction. Suitable trigger mechanisms may include, without limitation, commercially available push-push latches, cabinet latches, glove-box latches, friction-based detents, cam locks, or other releasable retention mechanisms capable of maintaining the rod-receiving member in a cocked position and releasing in response to a force applied by the fishing rod. Such mechanisms may rely on frictional engagement, geometric interference, spring bias, or combinations thereof.

Trigger mechanisms may further include spring-loaded plungers, index detents, or arrays of resilient contact members configured to resist downward rod deflection until a threshold is exceeded, thereby functioning as a non-latching trigger for strike detection.

### Environmental Hardening and Drainage

To ensure reliable operation in freezing conditions (e.g., ice fishing) or marine environments, the apparatus acts to prevent immobilization of the trigger mechanism due to ice formation. The rod-receiving member and base assembly may incorporate drainage apertures strategically positioned adjacent to the latch, sear, and actuator interface to allow water to evacuate rather than pooling and freezing. Additionally, the trigger assembly may be constructed with tolerances or hydrophobic coatings that resist ice adhesion, while any electronic alert components are potted or sealed within a waterproof enclosure to withstand moisture and sub-freezing temperatures.

### Rod Retention and Fixed Fulcrum Dynamics

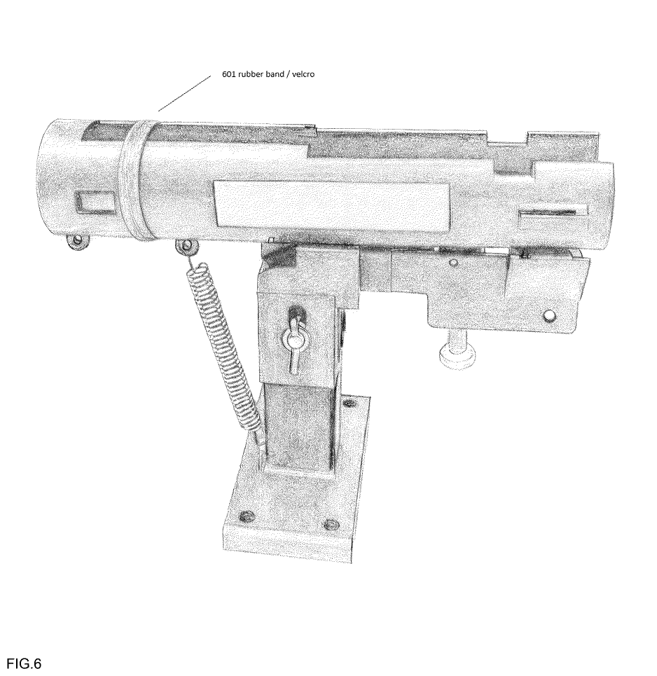

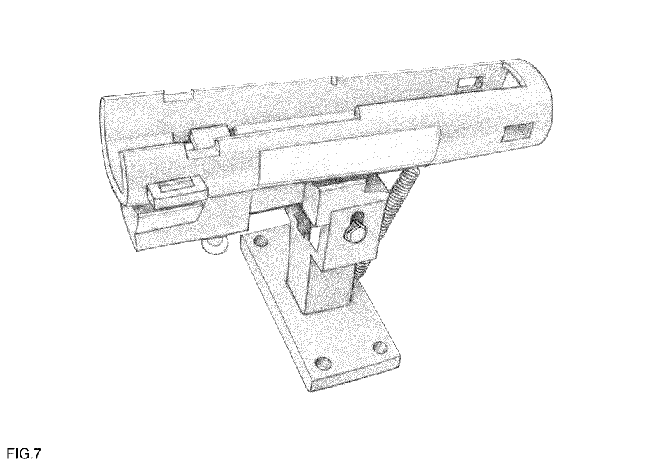

Referring to FIG. 6 and FIG. 7, the rod-receiving member features a top longitudinal opening. A key feature of this embodiment is that the opening is narrowed at the proximal end (rear) of the tube to a width less than the standard diameter of a fishing rod handle. This configuration creates an interference snap-fit that securely retains the fishing rod, preventing it from being ejected during the high-velocity hook-setting motion. The interior surface of the receiving cavity may optionally be lined with a compliant material, such as rubber, foam, or a polymer coating, to enhance grip and prevent abrasion of the fishing rod handle. Additionally, this positive retention feature facilitates single-handed operation. Once the rod handle is snapped into the narrowed opening, it is held self-supported, allowing the angler to use a single hand to pivot the rod-receiving member and engage the latch without needing to manually stabilize the rod against the spring tension. As illustrated in FIG. 7, the rod-receiving member further comprises external attachment points or “ears” located on the housing. These features serve as universal mounting interfaces, allowing the user to attach auxiliary accessories such as clip-on fishing bells for auditory alerts or additional safety straps for rough water conditions. Furthermore, this narrowed proximal end establishes a fixed fulcrum point. When a fish strikes, the fishing rod handle is confined at the rear of the tube. Consequently, a downward deflection of the rod tip causes the rod to act as a first-class lever against this fixed fulcrum, amplifying the downward force applied to the actuator interface located distal to the fulcrum. This mechanical advantage allows the device to detect subtle strikes (“nibbles”) and translate them into sufficient force to disengage the latch.

### Operational Sequence

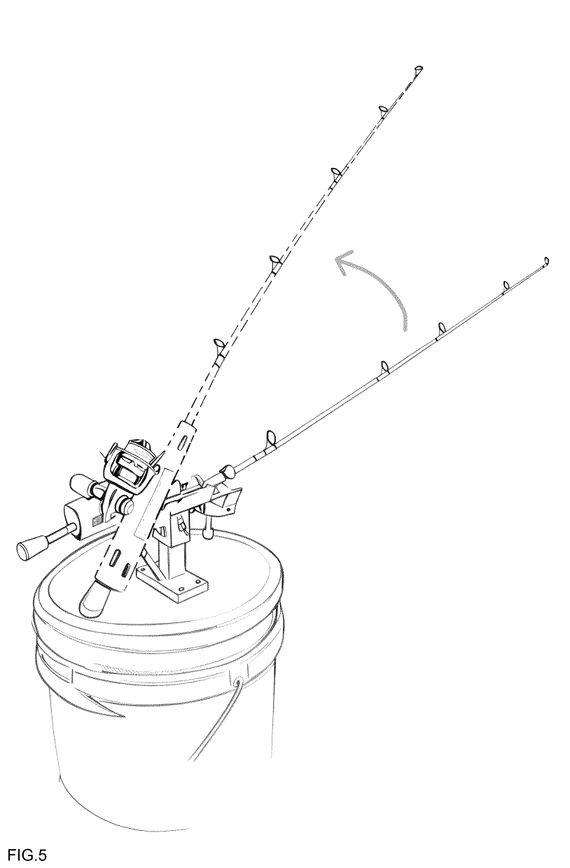

A. Set State: As shown in FIG. 6, the user pivots the rod-receiving member downward into a horizontal position. The sear engagement interface catches the latching pin. The primary biasing element is extended, storing potential energy. B. Triggering Event: As illustrated in FIG. 5, a fish strike pulls the rod tip downward. The rod handle pivots inside the tube, pressing against the actuator interface. This pressure overcomes the secondary biasing force of the adjustment spring, causing the monolithic latch member to pivot. C. Release: The sear disengages from the latching pin. The primary biasing element instantly retracts, swinging the rod-receiving member upward to set the hook.

### Safety Lockout and Multi-mode Functionality

The sensitivity adjustment assembly provides a safety lockout configuration. By advancing the adjustment member to its maximum limit, the resilient member is fully compressed or the adjustment member physically contacts the latch, creating a rigid obstruction. In this state, the latch is immobilized, converting the automatic hook-setting rod holder into a static rod holder safe for transport or conventional fishing methods. Additionally, in an alternative configuration, a distinct safety mechanism such as a spring-loaded index plunger may be mounted to the latch bar. This plunger is configured to be manually engaged to physically block or bias the sear arm into a locked position, providing a positive mechanical safety stop distinct from the sensitivity adjustment knob.

The lockout state is functionally distinct from sensitivity adjustment and is configured to prevent release of the latch regardless of trigger input, rather than merely increasing a trigger threshold.

### Electronic Alert and “Alert-Only” Mode

In any of the described embodiments, the invention may further incorporate an electronic alert system. This system comprises a sensor—such as a mechanical limit switch, a magnetic Hall effect sensor, or an optical interrupter—positioned to detect the actuation of the trigger mechanism. Upon a strike, the triggering motion completes a circuit to activate an audible alarm, light, or wireless signal. This configuration allows for a distinct “Alert-Only” mode. By detaching or removing the primary biasing element, the user eliminates the automatic hook-setting force. In this state, the device functions solely as a fish detection system. When a fish strikes, the rod deflection trips the trigger and activates the sensor to alert the angler, but the rod-receiving member remains stationary. This mode is particularly advantageous for regulations where automatic hook-setting is restricted or when the angler prefers to set the hook manually after detection.

In an alternative alert-only embodiment, fish detection is achieved by permitting limited rotation of the rod-receiving member relative to the base assembly under a controlled frictional resistance at the pivot joint. In this configuration, adjustable friction at the hub defines a threshold rotational resistance, such that a fish strike produces detectable angular movement of the rod-receiving member without releasing a latch or actuating a hook-setting mechanism. Rotation of the rod-receiving member may be sensed mechanically or electronically to generate an alert. This embodiment is particularly suited for applications where automatic hook-setting is not desired.

### Alternative Embodiments

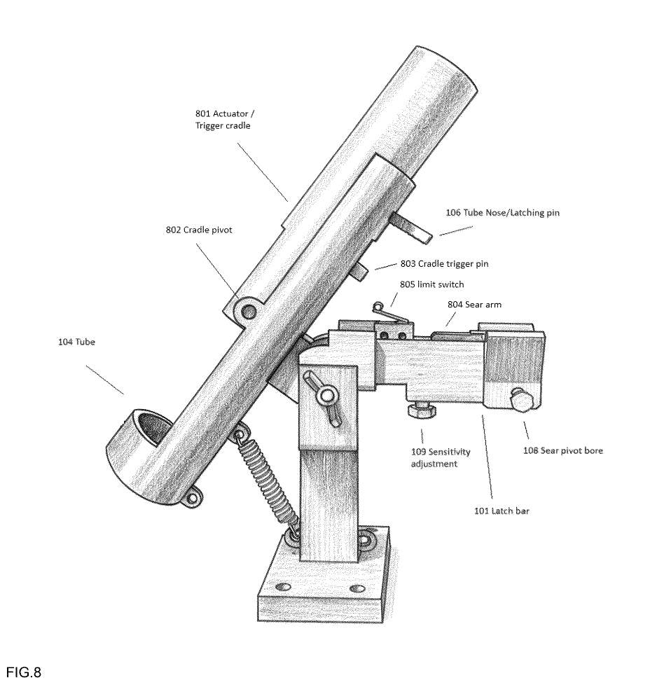

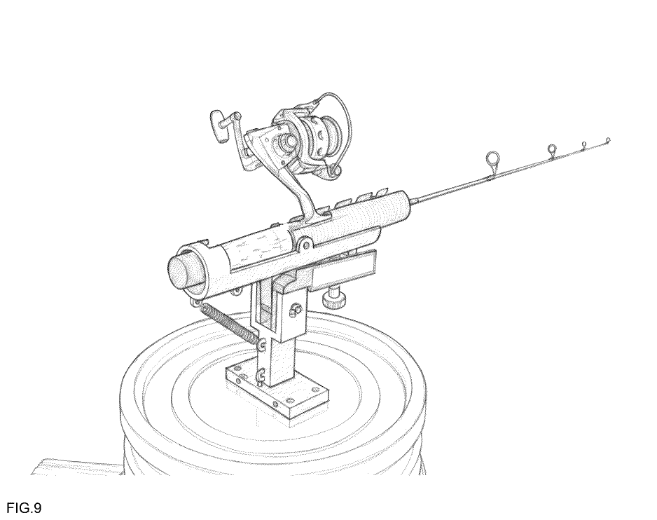

FIGS. 8 and 9 illustrate an alternative embodiment wherein the trigger mechanism is external. A trigger cradle resides on top of the rod-receiving member and pivots at a cradle pivot. A cradle trigger pin actuates an external sear arm to release the tube. This configuration provides significant modularity advantages. Because the rod-receiving member bears the structural load of the primary biasing element, replacing it to accommodate different rod sizes would require disassembling the high-tension spring assembly. By contrast, the trigger cradle acts as a non-load-bearing interchangeable interface. This allows the user to rapidly swap out cradles of varying geometries (e.g., wide cradles for cork handles, narrow cradles for split-grips) to achieve optimal fit and trigger sensitivity without disturbing the primary hook-setting mechanism. Furthermore, the position of the cradle pivot may be adjusted independently of the tube pivot, allowing for variable leverage ratios suited to specific rod lengths. Additionally, while the preferred embodiment utilizes a mechanical spring for the sensitivity adjustment, other biasing means are contemplated. For example, the sensitivity adjustment assembly may comprise a plurality of magnetic elements, wherein at least one magnet is movable to vary the magnetic flux density and attractive force acting on the latch, thereby providing a non-contact adjustable biasing force.

### Longitudinal Sensitivity Adjustment and Geometric Variations

In addition to, or in lieu of, the spring-based sensitivity adjustment, the apparatus allows for sensitivity calibration via the longitudinal positioning of the fishing rod. The rod-receiving member may define a longitudinal receiving cavity that allows the user to slide the fishing rod handle forward or backward relative to the actuator interface. Sliding the rod alters the distance between the rod's center of gravity and the fulcrum point established by the rod-receiving member. By shifting the rod, the user changes the effective moment arm, thereby varying the static torque applied to the trigger. A rod positioned further forward (away from the fulcrum) increases the leverage of the rod's weight, exerting more force on the actuator and making the release more sensitive. Conversely, a rod positioned further backward (closer to the fulcrum) reduces this leverage, requiring a stronger strike force to trigger the mechanism (less sensitive).

It is further contemplated that the sensitivity adjustment may be achieved by kinematic inversion. Instead of (or in addition to) moving the fishing rod, the actuator interface (or trigger cradle) itself may be configured to slide or be repositioned longitudinally along the rod-receiving member. Moving the actuator interface toward the fulcrum point reduces the effective lever arm of the rod's center of gravity relative to the trigger contact point, requiring greater force to actuate (lower sensitivity). Conversely, moving the actuator interface away from the fulcrum increases the mechanical advantage of the rod against the trigger (higher sensitivity). Thus, the invention encompasses any adjustment that alters the relative longitudinal distance between the rod's center of gravity, the fulcrum, and the actuator interface.

To facilitate this, the rod-receiving member may incorporate a plurality of transverse notches or slots intersecting the longitudinal cavity. These notches are sized to receive the stem of the fishing reel, locking the rod at discrete, repeatable longitudinal positions corresponding to specific sensitivity levels.

Furthermore, the retention feature that establishes the fulcrum is not limited to the “proximal snap-fit” arrangement of the preferred embodiment. In alternative configurations (such as that shown in FIG. 9), the retention section may be located at the distal (front) end of the tube or extend along the entire length. Additionally, the superior opening of this retention section need not be open; it may have a width dimension of zero, constituting a closed perimeter (e.g., a complete tube or ring) through which the rod handle is axially inserted. This “closed loop” geometry provides maximum security against rod ejection while still permitting the longitudinal sliding adjustment described above.

### Longitudinal Positioning Constraint and Retention Mechanisms

In addition to the geometric retention features described above, the system may allow for —or explicitly include—a longitudinal positioning constraint 601, as generally illustrated in FIG. 6. While the sliding adjustment of the fishing rod allows for variable sensitivity tuning, it is advantageous to maintain a precise, repeatable position once the optimal sensitivity is established.

The positioning constraint 601 is configured to restrict the longitudinal translation of the fishing rod relative to the rod-receiving member. This ensures that the distance between the rod's center of gravity and the fulcrum remains constant, even under wind load or during the initial moments of a strike. The invention contemplates several embodiments for this constraint:

A. External Resilient Constriction (FIG. 6 Embodiment) In one embodiment, the positioning constraint 601 comprises a flexible, resilient member disposed around the exterior of the rod-receiving member's proximal end. As shown in FIG. 6, this may take the form of a rubber band, O-ring, Velcro® strap, or elastic collar.

Operation: Because the proximal end of the rod-receiving member features a split or open-top geometry, tightening this resilient member compresses the housing walls inward against the fishing rod handle. This creates a variable friction lock that prevents the rod from sliding axially but allows for intentional adjustment by the user.

B. Integrated Mechanical Clamp In an alternative embodiment, the positioning constraint 601 comprises a rigid mechanical clamp integrated into the rod-receiving member.

Cam-Lock: The housing may feature a cam-lever mechanism. When the lever is depressed, it actuates a pressure plate or biases the flexible walls of the housing inward to clamp the rod handle. Threaded Fastener: The housing may incorporate a thumb screw or threaded knob that passes through the wall of the rod-receiving member to bear against the rod handle (or a protective shim), mechanically locking the rod in place.

C. Rod-Mounted Stop Collar (“The Memory Ring”) In another embodiment, the positioning constraint 601 is distinct from the housing and is instead attached directly to the handle of the fishing rod.

Configuration: This may comprise a split-ring, a clip-on collar, or a movable O-ring that firmly grips the rod handle. Function: The user slides this collar along the rod handle to a specific position. When the rod is inserted into the rod-receiving member, the collar abuts the front or rear face of the tube (or a specific slot therein). This creates a positive mechanical stop, allowing the user to remove the rod to catch a fish and re-insert it to the exact same depth—and thus the exact same sensitivity setting—without recalibration. This embodiment satisfies the “visual reference index” requirement of the claims by physically marking the “sweet spot” on the rod itself.

D. Internal Friction Elements The rod-receiving member may further comprise internal high-friction elements to act as a passive positioning constraint.

Liner: The interior surface of the receiving cavity may be lined with directional gripping material, silicone ribs, or an elastomeric sleeve that resists axial sliding of the rod unless a threshold force is applied by the user.

E. Geometric Constraint (FIG. 9) Alternatively, the positioning constraint 601 may be integral to the housing geometry, as illustrated in FIG. 9. In this embodiment, the rod-receiving member comprises a plurality of transverse notches or slots intersecting the longitudinal receiving cavity. These notches are sized to receive the stem of the fishing reel.

Function: When the reel stem is seated in a specific notch, the rod is mechanically locked against longitudinal translation (satisfying the restriction requirement). Visual Index: The notches themselves act as the visual reference index (e.g., “Position 1,” “Position 2”), allowing the user to return to a known sensitivity setting instantly.

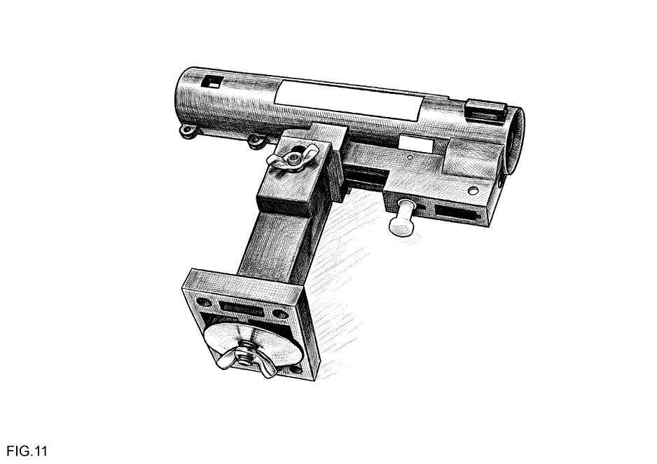

### Universal Mounting Interface (FIG. 11)

Referring to FIG. 11, the base assembly further comprises a versatile mounting interface located at the distal end of the support stem. Unlike localized ground stakes found in prior art, the present invention features a planar mounting flange configured with a central aperture or slot. This geometry facilitates a “single-bolt” mounting architecture, allowing the apparatus to be strictly secured to a wide variety of substrates using a single threaded fastener.

In the embodiment depicted in FIG. 11, the mounting interface is shown with a wingnut and washer assembly. It is expressly contemplated that the fastening orientation is reversible to accommodate different platforms. For example, in a “bottom-up” configuration, a bolt may pass through a substrate (such as the lid of a bucket) and into the base of the apparatus, secured by a nut housed within the stem or the wingnut shown. Conversely, in a “top-down” configuration, a bolt or threaded stud may extend from the base into a receiving nut or threaded socket.

This universal interface ensures compatibility with standard equipment. For instance, the aperture may be sized to accept standard camera tripod threading or other common hardware sizes, allowing the hook-setting rod holder to be mounted directly onto tripods for use on rocky banks or ice. Alternatively, the flat flange allows for stable mating with thin-walled surfaces, such as plastic cooler lids or bucket lids, effectively turning common fishing storage containers into stable bases for the automatic hook-setter.

1. An automatic hook-setting rod holder comprising: a base assembly and a rod-receiving member pivotally coupled thereto; a primary biasing element urging the rod-receiving member toward a released position; a trigger mechanism comprising a latch and an actuator interface positioned to receive force from a physical deflection of a fishing rod; and a sensitivity adjustment assembly configured to vary a release threshold of the latch by applying an adjustment force to the trigger mechanism in a vector substantially perpendicular to a friction vector generated by the primary biasing element, wherein the release threshold is adjustable independently of a magnitude of the primary biasing force.

2. The hook-setting rod holder of claim 1, wherein the sensitivity adjustment assembly exerts a biasing force that resists actuation of the latch in response to the physical deflection of the fishing rod, thereby establishing a resistance threshold that the fishing rod must overcome to actuate the latch, such that the release threshold is determined by balancing the rod-applied force against the adjustment force.

3. The hook-setting rod holder of claim 1, wherein the latch comprises a pivotable sear having a latching surface and an actuator interface arranged about a sear pivot axis, such that a distance from the actuator interface to the sear pivot axis is greater than a distance from the latching surface to the sear pivot axis, thereby configuring the sear to produce a mechanical advantage sufficient to render frictional forces acting on the latching surface negligible with respect to the release threshold.

4. The hook-setting rod holder of claim 1, wherein the primary biasing element is selected from the group consisting of tension springs, torsion springs, and elastomeric components.

5. The hook-setting rod holder of claim 1, wherein the sensitivity adjustment assembly comprises at least one resilient member and an adjustment member configured to selectively vary a compression of the resilient member.

6. The hook-setting rod holder of claim 1, wherein the rod-receiving member comprises a proximal end having a top longitudinal opening with a width narrower than a diameter of a fishing rod handle, configured to provide an interference fit that retains the fishing rod during setting, and wherein the proximal end defines a fixed fulcrum about which the fishing rod pivots during a downward deflection, thereby creating a lever arm between the proximal end and the actuator interface that amplifies the force applied to the latch to improve consistency of the release threshold.

7. The hook-setting rod holder of claim 1, wherein the actuator interface comprises a contoured pad configured to be triggered by contact from the fishing rod, and wherein the latch and the actuator interface are integrated into a monolithic unitary member pivotally mounted within the rod-receiving member.

8. The hook-setting rod holder of claim 1, wherein the base assembly comprises a stem and a latch bar, further comprising an angular adjustment assembly coupling the stem and the latch bar, the angular adjustment assembly including interlocking radial face splines configured to allow incremental angular adjustment of the latch bar relative to the stem while permitting the rod-receiving member to rotate freely relative to the latch bar upon release.

9. The hook-setting rod holder of claim 1, wherein the sensitivity adjustment assembly comprises a plurality of magnetic elements, at least one of which is movable to vary a magnetic flux density, thereby providing an adjustable biasing force on the latch.

10. The hook-setting rod holder of claim 1, further comprising an electronic alert system including a sensor configured to detect actuation of the trigger mechanism, wherein the hook-setting rod holder is configurable to an alert-only mode by decoupling the primary biasing element, and wherein the trigger mechanism remains latched and responsive to the sensitivity adjustment assembly in the absence of the primary biasing element, such that a physical deflection of the fishing rod actuates the trigger mechanism and triggers the electronic alert without pivoting the rod-receiving member.

11. The hook-setting rod holder of claim 1, further comprising a safety lockout configuration wherein the sensitivity adjustment assembly is adjustable to a limit state that physically obstructs the latch from releasing, thereby converting the hook-setting rod holder into a static rod holder.

12. The hook-setting rod holder of claim 1, further comprising a binary safety mechanism comprising a blocking member manually movable between a disengaged position and an engaged position to immobilize the trigger mechanism.

13. The hook-setting rod holder of claim 1, wherein the actuator interface comprises a trigger cradle pivotally coupled to an exterior surface of the rod-receiving member, said trigger cradle configured to pivot independently of the rod-receiving member to actuate an external sear arm, thereby allowing the trigger cradle to be interchanged without disassembling the primary biasing element.

14. The hook-setting rod holder of claim 1, wherein the base assembly terminates in a planar mounting flange comprising a single-fastener aperture, said single-fastener aperture configured to receive a threaded bolt in either a top-down or bottom-up orientation to secure the hook-setting rod holder to an external support structure, such as a container lid or a tripod.

15. A method for automatically setting a fishing hook using a biased rod holder, the method comprising: positioning a handle of a fishing rod within a pivotable rod-receiving member; engaging a latch to hold the pivotable rod-receiving member in a cocked position against a primary biasing force; adjusting a trigger sensitivity by applying a secondary force in a vector substantially perpendicular to a friction vector generated by the primary biasing force at a latch interface; and releasing the latch via a downward deflection of the fishing rod onto an actuator interface supported by the rod-receiving member.

16. The method of claim 15, wherein the step of positioning the fishing rod handle comprises confining the handle within a proximal end of the rod-receiving member via a narrowed top opening to establish a fixed fulcrum, thereby creating a lever arm between said proximal end and the actuator interface that amplifies the force of the fishing rod deflection against the latch.

17. The method of claim 15, wherein the step of releasing the latch comprises moving the fishing rod relative to the rod-receiving member to actuate the latch while the rod-receiving member remains stationary relative to a base assembly, until the release threshold is exceeded and the rod-receiving member rotates.

18. The method of claim 15, wherein releasing the latch is achieved by the direct rotation of an integrated monolithic member comprising both the actuator interface and the latch, the rotation occurring about a pivot axis located within the rod-receiving member.

19. The method of claim 15, further comprising converting the biased rod holder to a static rod holder by advancing an adjustment member until the latch is immobilized in a locked state.

20. The method of claim 15, wherein the latch is operationally coupled to the actuator interface, said actuator interface comprising a detachable trigger cradle pivotally coupled to an exterior of the rod-receiving member, the method further comprising interchanging said detachable trigger cradle with a second trigger cradle of a different geometry to accommodate a different fishing rod handle without disassembling a primary biasing element of said biased rod holder.

21. An automatic hook-setting rod holder comprising: a base assembly; a rod-receiving member pivotally coupled to the base assembly; a primary biasing element urging the rod-receiving member toward a released position; and a trigger mechanism configured to releasably maintain the rod-receiving member in a cocked position, wherein the trigger mechanism comprises an actuator interface positioned to receive force from a fishing rod; wherein the rod-receiving member defines a longitudinal receiving cavity configured to support a handle of the fishing rod while constraining the handle against vertical disengagement during a hook-setting motion; wherein a longitudinal position of the fishing rod within the longitudinal receiving cavity establishes a moment arm between a center of gravity of the fishing rod and a fulcrum point of the rod-receiving member, such that a weight of the fishing rod produces torque about the fulcrum point; and wherein a sensitivity of the trigger mechanism is adjustable by altering the longitudinal position of the fishing rod relative to the actuator interface, thereby varying a distance between the center of gravity of the fishing rod and the fulcrum point to vary a torque applied to the actuator interface.

22. The hook-setting rod holder of claim 21, further comprising a longitudinal positioning constraint disposed on or about the handle of the fishing rod, wherein the longitudinal positioning constraint is configured to: (a) provide a visual reference index relative to the rod-receiving member for establishing a calibrated longitudinal position of the fishing rod; (b) engage the rod-receiving member to restrict longitudinal translation of the fishing rod relative to the rod-receiving member in response to external axial forces; and (c) establish a fixed fulcrum axis about which the fishing rod pivots to actuate the trigger mechanism, thereby maintaining a consistent lever-arm length for sensitivity of the trigger mechanism.

23. The hook-setting rod holder of claim 21, wherein the rod-receiving member comprises a retention section that establishes the fulcrum point, said retention section having a superior opening defined by a width dimension ranging from zero, constituting a closed perimeter section, to a non-zero value less than a diameter of the fishing rod handle, such that the fishing rod handle is captivated within the retention section.

24. A method for calibrating a trigger sensitivity of an automatic hook-setting rod holder, the method comprising: providing a rod holder comprising a pivotable rod-receiving member and a trigger mechanism having an actuator interface; positioning a handle of a fishing rod within a longitudinal cavity of the rod-receiving member such that the handle engages a fulcrum point; and adjusting a sensitivity of the trigger mechanism by altering a longitudinal position of the fishing rod relative to the actuator interface, thereby varying a distance between a center of gravity of the fishing rod and the fulcrum point to modify a static torque applied by the fishing rod against the actuator interface.
